(19) United States
(12) Patent Application Publication
(10) Pub. No.: US 2021/0224468 A1
(43) Pub. Date: Jul. 22, 2021

(54) WEB RENDERING FOR SMART MODULE

(71) Applicant: FORD GLOBAL TECHNOLOGIES, LLC, Dearborn, MI (US)

(72) Inventors: Pietro BUTTOLO, Dearborn Heights, MI (US); Yifan CHEN, Ann Arbor, MI (US); James Stewart RANKIN, II, Novi, MI (US); Mengchi WANG, Dearborn, MI (US); Abhishek SHARMA, Novi, MI (US); Stuart C. SALTER, White Lake, MI (US)

(21) Appl. No.: 17/222,315

(22) Filed: Apr. 5, 2021

Related U.S. Application Data
(63) Continuation of application No. 15/420,697, filed on Jan. 31, 2017, now abandoned.

(51) Int. Cl. G06F 40/143; G06F 16/951; G06F 40/197; G06F 40/123; G06F 40/186; G06F 3/0482; H04L 29/08

(52) U.S. Cl. CPC G06F 40/143; G06F 16/951; G06F 40/197; G06F 3/04817; G06F 40/186; G06F 3/0482; H04L 67/12; G06F 40/123

(57) ABSTRACT

A system includes a personal device in communication with a vehicle component and an on-board server and including a processor programmed to receive, from the component, an advertisement defining a low-footprint interface template and a unique identifier indicative of a corresponding rich content interface template, send, to the server, a request including the identifier to provide the corresponding template, and, upon receipt of the corresponding template, render a rich content user interface based on the corresponding template.

### TECHNICAL FIELD

The present disclosure relates to systems and methods for rendering interfaces on a personal device connected with an in-vehicle component.

### BACKGROUND

As personal devices become more interconnected, there is an opportunity to integrate more intelligence and sensing into the vehicle interior and exterior components. Moreover, integrating personal devices with the vehicle components may enable a radically new user experience. For example, vehicle interior controllers may be equipped with a communication interface, such as Bluetooth LE, or may use other methods to communicate with one or more personal devices. A personal device in communication with a vehicle component may receive a template of the functionalities and controls offered by the component, as well as a template for an interface layout.

00031 In choosing among various interface templates, there may be a tradeoff between presenting a user with a graphically sophisticated interface and a presenting an interface at a quick speed. In one example, the in-vehicle component may broadcast a template for a graphically “rich” interface that may be better processed by powerful microcontrollers defining a local web server. Additionally or alternatively, the in-vehicle component may broadcast a less visually appealing (or a “lean”) interface template that may nevertheless be processed by microcontrollers having relatively low amounts of memory. In still another example, the in-vehicle component may offer an improved graphic content of a hybrid interface scheme by broadcasting vector graphics icons and layouts.

### SUMMARY

A system includes a personal device in communication with a vehicle component and an on-board server and including a processor programmed to receive, from the component, an advertisement defining a low-footprint interface template and a unique identifier indicative of a corresponding rich content interface template, send, to the server, a request including the identifier to provide the corresponding template, and, upon receipt of the corresponding template, render a rich content user interface based on the corresponding template.

A vehicle system includes an interface template server including a data store and a wireless transceiver configured to establish communication with a personal device, the server being configured to, in response to a request from the personal device, query the data store to identify a rich content interface template corresponding to a unique identifier received with the request and, upon identification, send the corresponding template to the personal device.

### BRIEF DESCRIPTION OF THE DRAWINGS

FIG. 1A is a block diagram illustrating an example vehicle system including a mesh of in-vehicle components configured to locate and interact with users and personal devices of the users;

FIG. 1B is a block diagram illustrating an in-vehicle component configured to detect presence and proximity of the personal devices;

FIG. 1C is a block diagram illustrating the in-vehicle component requesting signal strength from other in-vehicle components of the vehicle;

FIG. 1D is a block diagram illustrating a system for rendering a user interface based on one or more interface templates;

FIG. 2 is a block diagram illustrating an example mapping between controls of a user interface derived from a low-footprint interface template and a user interface derived from a rich content interface template;

FIG. 3 is a block diagram of the personal device requesting, from an on-board server, the rich content interface template that corresponds to a unique identifier;

FIG. 4 is a block diagram of the personal device requesting, from a vehicle component interface template server, the rich content interface template that corresponds to the unique identifier;

FIG. 5 is a block diagram of the personal device requesting, from local storage, the rich content interface template that corresponds to the unique identifier;

FIG. 6 is a block diagram of the on-board server requesting, from the vehicle component interface template server, the rich content interface template in response to detecting that the interface template corresponding to the unique identifier is not available;

FIG. 7 is an example information exchange flow between the in-vehicle component, the personal device, the on-board server;

FIG. 8 is an example information exchange flow between the in-vehicle components, the personal device, the on-board server, and the vehicle component interface template server;

FIG. 9 is a flowchart illustrating an algorithm for advertising a low-footprint interface template and advertising the unique identifier indicative of the rich content interface template; and

FIG. 10 is a flowchart illustrating an algorithm for requesting the rich content interface template in response to detecting that the interface template corresponding to the unique identifier is not available.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Integration of a personal mobile device may be implemented using a variety of approaches. A graphically “rich” interface in one or more personal devices may be provided using embedded servers to render the interface as web content. As some examples, routers, network cameras, and media gateways may provide an interface including a web page rendered by an embedded web server. In some cases, a web server may include a large memory footprint and computational power requirements and may include microprocessors and memory controllers that are more advanced and may, therefore, be more expensive than similar components meeting lesser requirements. Technical solutions compatible with, or alternative to, an implementation of a user interface using a web server are needed.

The personal device may use one or more templates to render a user interface for controlling a vehicle interior component in a layered architecture. In one example, the personal device may detect an advertisement from the in-vehicle component including the interface template defining a low footprint interface that guarantees a system responsiveness and low cost requirements. In another example, the personal device may detect an advertisement from the in-vehicle component including an interface template defining a more graphically “rich” interface, but requiring additional computation power and memory to render.

In still another example, the in-vehicle component may advertise a “lean” (or a low-footprint) user interface template and may advertise a unique identifier or a web address indicative of a corresponding rich content interface template, such as, but not limited to, interface templates based on a hypertext markup language (HTML), extensible hypertext markup language (XHML), scalable vector graphics (SVG), extensible application markup language (XAML), JavaScript Object Notation (JSON), and so on. The personal device may request the rich content interface templates from an on-board server, local storage, and a vehicle component interface template server. The personal device may further request the rich content interface templates from the on-board server that in turn may request the interface template from the vehicle component interface template server if it is not available in its own data store. Access to the low-footprint interface may enable the user to interact with the smart controller even in scenarios where the rich content interface may be unavailable due to a limited cellular coverage, such as, but not limited to, remote geographic locations, covered structures and so on.

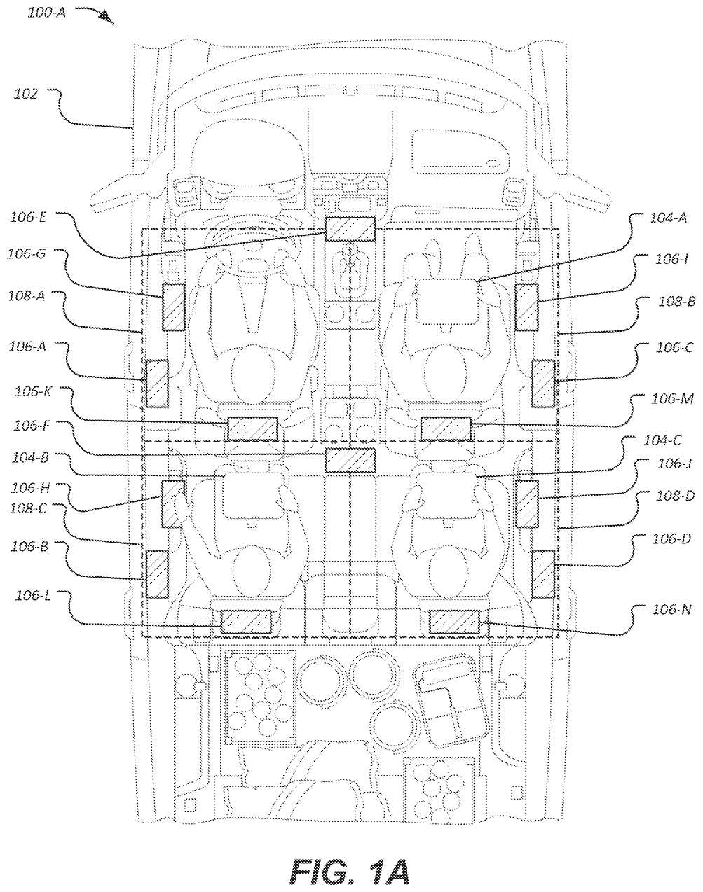

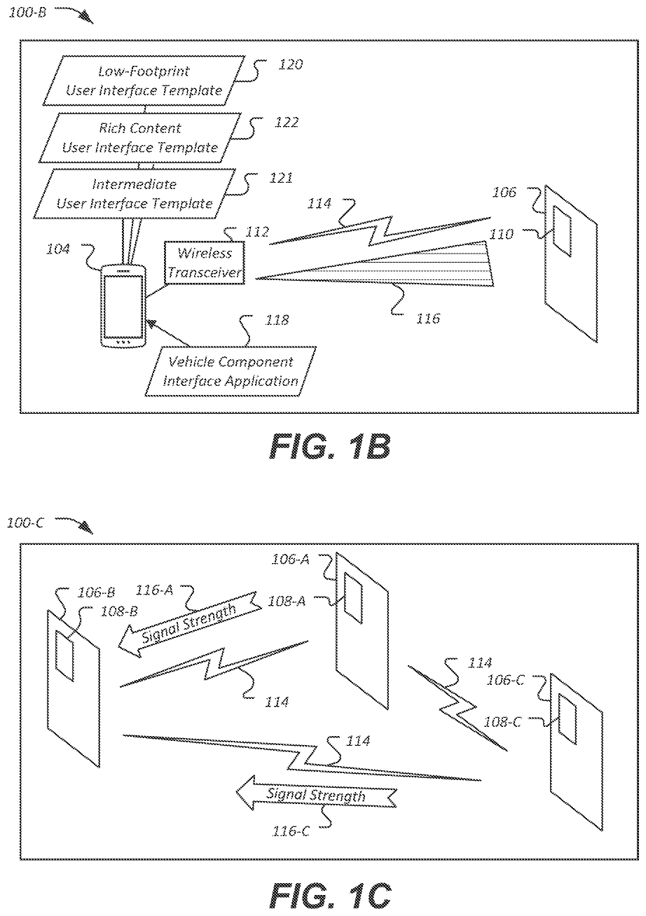

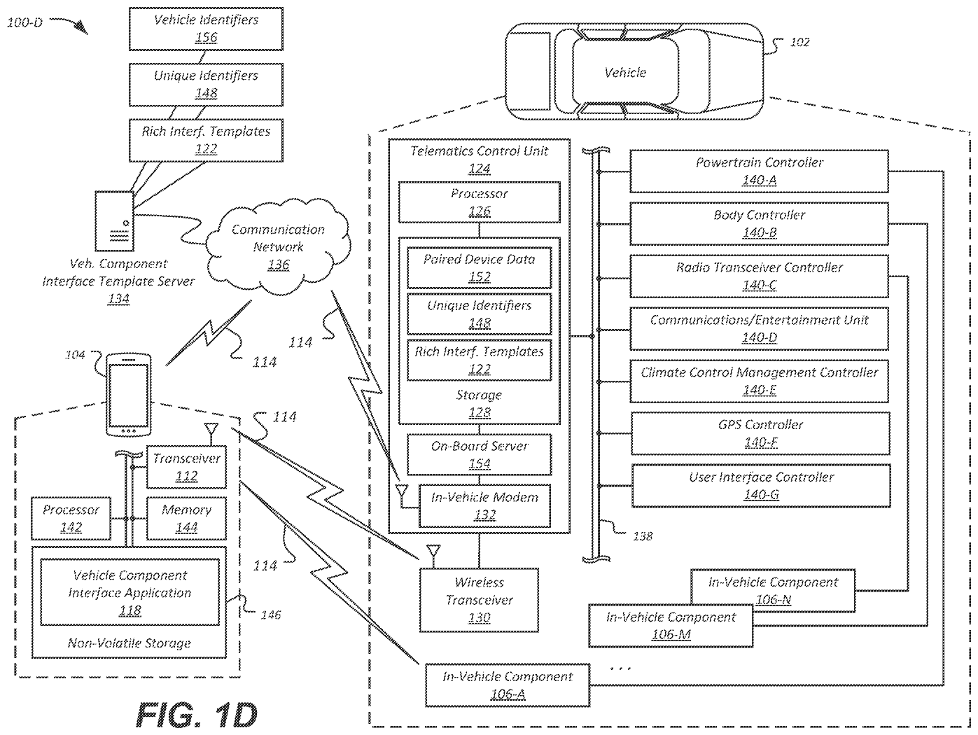

FIG. 1A illustrates an example system 100 including a vehicle 102 having a mesh of in-vehicle components 106 configured to locate and interact with users and personal devices 104 of the users. The system 100 may be configured to allow the users, such as vehicle occupants, to seamlessly interact with the in-vehicle components 106 in the vehicle 102 or with any other framework-enabled vehicle 102. Moreover, the interaction may be performed without requiring the personal devices 104 to have been paired with or be in communication with a head unit or other centralized computing platform of the vehicle 102.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume.

The personal devices 104-A, 104-B and 104-C (collectively 104) may include mobile devices of the users, and/or wearable devices of the users. The mobile devices may be any of various types of portable computing device, such as cellular phones, tablet computers, smart watches, laptop computers, portable music players, or other devices capable of networked communication with other mobile devices. The wearable devices may include, as some non-limiting examples, smartwatches, smart glasses, fitness bands, control rings, or other personal mobility or accessory device designed to be worn and to communicate with the user's mobile device.

The in-vehicle components 106-A through 106-N (collectively 106) may include various elements of the vehicle 102 having user-configurable settings. These in-vehicle components 106 may include, as some examples, overhead light in-vehicle components 106-A through 106-D, climate control in-vehicle components 106-E and 106-F, seat control in-vehicle components 106-G through 106-J, and speaker in-vehicle components 106-K through 106-N. Other examples of in-vehicle components 106 are possible as well, such as rear seat entertainment screens or automated window shades. In many cases, the in-vehicle component 106 may expose controls such as buttons, sliders, and touchscreens that may be used by the user to configure the particular settings of the in-vehicle component 106. As some possibilities, the controls of the in-vehicle component 106 may allow the user to set a lighting level of a light control, set a temperature of a climate control, set a volume and source of audio for a speaker, and set a position of a seat.

The vehicle 102 interior may be divided into multiple zones 108, where each zone 108 may be associated with a seating position within the vehicle 102 interior. For instance, the front row of the illustrated vehicle 102 may include a first zone 108-A associated with the driver seating position, and a second zone 108-B associated with a front passenger seating position. The second row of the illustrated vehicle 102 may include a third zone 108-C associated with a driver-side rear seating position and a fourth zone 108-D associated with a passenger-side rear seating position. Variations on the number and arrangement of zones 108 are possible. For instance, an alternate second row may include an additional fifth zone 108 of a second-row middle seating position (not shown). Four occupants are illustrated as being inside the example vehicle 102, three of whom are using personal devices 104. A driver occupant in the zone 108-A is not using a personal device 104. A front passenger occupant in the zone 108-B is using the personal device 104-A. A rear driver-side passenger occupant in the zone 108-C is using the personal device 104-B. A rear passenger-side passenger occupant in the zone 108-D is using the personal device 104-C.

Each of the various in-vehicle components 106 present in the vehicle 102 interior may be associated with the one or more of the zones 108. As some examples, the in-vehicle components 106 may be associated with the zone 108 in which the respective in-vehicle component 106 is located and/or the one (or more) of the zones 108 that is controlled by the respective in-vehicle component 106. For instance, the light in-vehicle component 106-C accessible by the front passenger may be associated with the second zone 108-B, while the light in-vehicle component 106-D accessible by passenger-side rear may be associated with the fourth zone 108-D. It should be noted that the illustrated portion of the vehicle 102 in FIG. 1A is merely an example, and more, fewer, and/or differently located in-vehicle components 106 and zones 108 may be used.

Referring to FIG. 1B, each in-vehicle component 106 may be equipped with a wireless transceiver 110 configured to facilitate detection of and identify proximity of the personal devices 104. In an example, the wireless transceiver 110 may include a wireless device, such as a Bluetooth Low Energy (BLE) transceiver configured to enable low energy Bluetooth signal intensity as a locator, to determine the proximity of the personal devices 104. Detection of proximity of the personal device 104 by the wireless transceiver 110 may, in an example, cause a vehicle component interface application 118 of the detected personal device 104 to be activated.

In many examples the personal devices 104 may include a wireless transceiver 112 (e.g., a BLUETOOTH module, a ZIGBEE transceiver, a Wi-Fi transceiver, an IrDA transceiver, an RFID transceiver, etc.) configured to communicate with other compatible devices. As described further in reference to at least FIG. 1D, the wireless transceiver 112 of the personal device 104 may exchange data with the wireless transceiver 110 of the in-vehicle component 106 over a wireless connection 114. In another example, a wireless transceiver 112 of a wearable personal device 104 may communicate data with a wireless transceiver 112 of a mobile personal device 104 over a wireless connection 114. The wireless connections 114 may be a BLE connection, but other types of local wireless connection 114, such as Wi-Fi or Zigbee may be utilized as well.

The personal devices 104 may also include a device modem configured to facilitate communication of the personal devices 104 with other devices over a communications network, as shown, for example, in FIG. 1D. The communications network may provide communications services, such as packet-switched network services (e.g., Internet access, voice over internet protocol (VoIP) communication services), to devices connected to the communications network. An example of a communications network may include a cellular telephone network. To facilitate the communications over the communications network, personal devices 104 may be associated with unique device identifiers (e.g., mobile device numbers (MDNs), Internet protocol (IP) addresses, identifiers of the device modems, etc.) to identify the communications of the personal devices 104 over the communications network. These personal device 104 identifiers may also be utilized by the in-vehicle component 106 to identify the personal devices 104.

The vehicle component interface application 118 may be an application installed to the personal device 104. The vehicle component interface application 118 may be configured to facilitate vehicle occupant access to features of the in-vehicle components 106 exposed for networked configuration via the wireless transceiver 110. In some cases, the vehicle component interface application 118 may be configured to identify the available in-vehicle components 106, identify the available features and current settings of the identified in-vehicle components 106, and determine which of the available in-vehicle components 106 are within proximity to the vehicle occupant (e.g., in the same zone 108 as the location of the personal device 104).

The vehicle component interface application 118 may be further configured to display a user interface descriptive of the available features, receive user input, and provide commands based on the user input to allow the user to control the features of the in-vehicle components 106. Thus, the system 100 may be configured to allow vehicle occupants to seamlessly interact with the in-vehicle components 106 in the vehicle 102, without requiring the personal devices 104 to have been paired with or be in communication with a head unit of the vehicle 102.

The system 100 may use one or more device location-tracking techniques to identify the zone 108 in which the personal device 104 is located. Location-tracking techniques may be classified depending on whether the estimate is based on proximity, angulation or lateration. Proximity methods are “coarse-grained,” and may provide information regarding whether a target is within a predefined range but they do not provide an exact location of the target. Angulation methods estimate a position of the target according to angles between the target and reference locations. Lateration provide an estimate of the target location, starting from available distances between target and references. The distance of the target from a reference can be obtained from a measurement of signal strength 116 over the wireless connection 114 between the wireless transceiver 110 of the in-vehicle component 106 and the wireless transceiver 112 of the personal device 104, or from a time measurement of either arrival (TOA) or difference of arrival (TDOA).

One of the advantages of lateration using signal strength 116 is that it can leverage the already-existing received signal strength indication (RSSI) signal strength 116 information available in many communication protocols. For example, iBeacon uses the RSSI signal strength 116 information available in the Bluetooth Low-Energy (BLE) protocol to infer the distance of a beacon from a personal device 104 (i.e. a target), so that specific events can be triggered as the personal device 104 approaches the beacon. Other implementations expand on the concept, leveraging multiple references to estimate the location of the target. When the distance from three reference beacons are known, the location can be estimated in full (trilateration) from the following equations:

d₁²=(x−x₁)²+(y−y₁)²+(z−z₁)²

d₂²=(x−x₂)²+(y−y₂)²+(z−z₂)²

d₃²=(x−x₃)²+(y−y₃)²+(z−z₃)² (1)

In an example, as shown in FIG. 1C, an in-vehicle component 106-B may broadcast or otherwise send a request for signal strength 116 to other in-vehicle components 106-A and 106-C of the vehicle 102. This request may cause the other in-vehicle components 106-A and 106-C to return wireless signal strength 116 data identified by their respective wireless transceiver 110 for whatever devices they detect (e.g., signal strength 116-A for the personal device 104 identified by the wireless transceiver 110-A, signal strength 116-C for the personal device 104 identified by the wireless transceiver 110-C). Using these signal strengths 116-A and 116-C, as well as signal strength 116-B determined by the in-vehicle component 106-B using its wireless transceiver 110-B, the in-vehicle component 106-B may use the equations (1) to perform trilateration and locate the personal device 104. As another possibility, the in-vehicle component 106 may identify the personal device 104 with the highest signal strength 116 at the in-vehicle component 106 as being the personal device 104 within the zone 108 as follows:

$$Personal Device = i ⇒ {max}_{i = 1 , n} {RSSI}_{i} \qquad ( 2 )$$

Thus, the mesh of in-vehicle components 106 and the personal devices 104 may accordingly be utilized to allow the in-vehicle components 106 to identify in which zone 108 each personal device 104 is located.

To enable tracking of personal devices 104 within the vehicle 102, information descriptive of the location (e.g., zone 108) of each in-vehicle component 106 relative to the vehicle 102 interior may be to be broadcast by the in-vehicle components 106 to the other in-vehicle components 106 and personal devices 104. Moreover, to provide status information indicative of the current settings of the in-vehicle components 106, the in-vehicle components 106 may also broadcast status information and/or information indicative of when changes to the settings of the in-vehicle components 106 are made.

The vehicle component interface application 118 executed by the personal device 104 may be configured to scan for and update a data store of available in-vehicle components 106. As some examples, the scanning may be performed periodically, responsive to a user request to refresh, or upon activation of the vehicle component interface application 118. In examples where the scanning is performed automatically, the transition from vehicle 102 to vehicle 102 may be seamless, as the correct set of functionality is continuously refreshed and the user interface of the vehicle component interface application 118 is updated to reflect the changes.

BLE advertising packets in broadcasting mode may be used to communicate location, event, or other information from the in-vehicle components 106 to the personal devices 104. This may be advantageous, as the personal devices 104 may be unable to preemptively connect to each of the in-vehicle components 106 to receive status updates. In many BLE implementations, there is a maximum count of BLE connections that may be maintained, and the number of in-vehicle components 106 may exceed this amount. Moreover, many BLE implementations either do not allow for the advertisement of user data, or if such advertisement is provided, use different or incompatible data types to advertise it. However, location and event information may be embedded into the primary service UUID that is included in the advertisement packet made by the in-vehicle component 106.

In an example, the advertised information may include information packed into the primary service UUID for the in-vehicle component 106. This information may include a predefined prefix value or other identifier indicating that the advertisement is for an in-vehicle component 106. The advertisement may also include other information, such as location, component type, and event information (e.g., a counter that changes to inform a listener that the status of the component had changed and should be re-read). By parsing the service UUIDs of the advertisement data of the in-vehicle component 106, personal devices 104 and other in-vehicle components 106 scanning for advertisements may be able to: (i) identify the existence in the vehicle 102 of the in-vehicle component 106, (ii) determine its location and zone 108 within the vehicle 102, and (iii) detect whether a physical interaction has taken place between a user and the in-vehicle component 106 (e.g., when changes are identified to the advertised data).

FIG. 1D illustrates an example system 100-D including the vehicle 102 equipped with a telematics control unit (TCU) 124 configured to provide telematics services to the vehicle 102. The TCU 124 may include a processor 126 configured to execute firmware or software programs stored on one or more storage devices 128. The TCU 124 may further comprise an on-board server 154 including various types of computing apparatus including a memory on which computer-executable instructions may be maintained, where the instructions may be executable by one or more processors of the computing device.

The TCU 124 may include a wireless transceiver 130 configured to enable wireless communication 114 with the transceiver 112 of the personal device 104. The TCU 124 may also include an in-vehicle modem 132 configured to establish wireless communication 114 with a vehicle component interface template server 134 using a wireless communication network 136. As still another example, the TCU 124 may utilize the modem services of the wireless transceiver 130 for communication with the personal device 104 and/or the template server 134 over the communication network 136.

The vehicle 102, the personal devices 104 of a user, and the interface template server 134 may, accordingly, be configured to communicate over one or more of Bluetooth, Wi-Fi, and wired USB. The wireless transceiver 130, the in-vehicle modem 132, and a corresponding transceiver of the interface template server 134 may each include network hardware configured to facilitate communication over the communication network 136 between the vehicle 102 and other devices of the system 100. The communication network 136 may include one or more interconnected communication networks such as the Internet, a satellite link network, a local area network, a wide area network, a wireless local area network (WLAN) including dedicated short range communication (DSRC), a cellular network, and a telephone network, as some non-limiting examples.

The personal device 104 may undergo a process the first time the personal device 104 is connected to the TCU 124, in which the TCU 124 scans for personal devices 104, and the user manually confirms an identification of the personal device 104 to be connected to the TCU 124. This process may be referred to as pairing. The TCU 124 may maintain paired device data 152 indicating device identifiers or other information regarding personal devices 104 that have been previously paired with the TCU 124. Accordingly, once the pairing process is performed, the TCU 124 may utilize the paired device data 152 to automatically reconnect to the personal device 104 when the personal device 104 is identified via the wireless transceiver 130 as being in proximity of the TCU 124.

As described in reference to at least FIG. 1A, the personal devices 104 may be any of various types of portable computing devices, such as cellular phones, tablet computers, smart watches, laptop computers, portable music players, or other devices capable of communication over the communication network 136 and/or the wireless connection 114. In an example, the transceiver 112 of the personal device 104 may communicate with one or more devices connected to the communication network 136 and/or with the wireless transceiver 130 of the vehicle 102. The personal devices 104 may include one or more processors 142 configured to execute instructions of mobile applications loaded to a memory 144 of the personal device 104 from storage medium 146 of the personal device 104. The vehicle component interface application 118 may be an example of a mobile application installed to the personal device 104. The vehicle component interface application 118 may be configured to receive input (e.g., user input to a user interface of the personal device 104), and send commands to the vehicle 102 via the TCU 124, as discussed in greater detail below.

The TCU 124 may use vehicle bus 138 to communicate with various hardware and software components of the vehicle 102, such as, but not limed to, the one or more vehicle controllers 140 (represented as discrete controllers 140-A through 140-G). The vehicle bus 138 may include various methods of communication available between and among the vehicle controllers 140 and the TCU 124. As some non-limiting examples, the vehicle bus 138 may include one or more of a vehicle controller area network (CAN), an Ethernet network, and a media oriented system transfer (MOST) network.

The controllers 140 may define, or be connected to, the one or more in-vehicle components 106, such as the in-vehicle components 106-A through 106-N described in reference to FIG. 1A, and may, accordingly, be configured to monitor and manage various vehicle 102 functions. The controllers 140 may include one or more processors (e.g., microprocessors) (not shown) configured to execute firmware or software programs stored on one or more storage devices (not shown) of the controller 140. While the controllers 140 are illustrated as separate components, the vehicle controllers 140 may share physical hardware, firmware, and/or software, such that the functionality from multiple controllers 140 may be integrated into a single controller 140, and that the functionality of various such controllers 140 may be distributed across a plurality of controllers 140.

The personal device 104 may include a processor 142 configured to execute firmware or software programs loaded to memory 144 from one or more storage devices 146. The personal device 104 may include the vehicle component interface application 118 configured to display a user interface corresponding to the one or more in-vehicle components 106 in response to receiving one or more interface templates 120, 122.

In one example, the vehicle component interface application 118 may be configured to receive one or more interface templates via the communication network 136 and/or via the wireless connection 114 to the TCU 124 or to the one or more in-vehicle components 106. The vehicle component interface application 118 may be further configured to receive a unique identifier and/or a web address indicating a corresponding interface template. The storage 128 of the TCU 124 may, for instance, be configured to store a plurality of unique identifiers 148 and corresponding rich content interface templates 122. In response to a request from the personal device 104, the TCU 124 may be configured to provide the rich content interface template 122 corresponding to the unique identifier 148 received from the personal device 104. While an example system 100-D is shown in FIG. 1D, the example components illustrated are not intended to be limiting. Indeed, the system 100-D may have more or fewer components, and additional or alternative components and/or implementations may be used.

The on-board server 154 may be configured to maintain an access portal accessible to personal devices 104 over the wireless connection 114 and/or the communication network 136. In an example, the on-board server 154 may be configured to provide the access portal to devices connected to the on-board server 154 via the wireless transceiver 130 and/or via the in-vehicle modem 132. As another possibility, the on-board server 154 may execute a server application that may be accessed by a dedicated client application, e.g., the vehicle component interface application 118, of a connecting personal device 104. Accordingly, the access portal of the on-board server 154 may provide a user interface to the personal devices 104 allowing the personal devices 104 to request vehicle component interface templates 120, 122.

The on-board server 154 may perform authentication of the personal device 104 to ensure that the personal devices 104 have permission to access the provided vehicle component interface template. If the authentication is successful, the on-board server 154 may send the requested vehicle component interface templates (e.g., the low-footprint user interface template 120, the rich content interface template 122, and so on) to the personal device 104 for processing.

The vehicle component interface template server 134 may include various types of computing apparatus, such as a computer workstation, a server, a desktop computer, a virtual server instance executed by a mainframe server, or some other computing system and/or device. The vehicle component interface template server 134 may generally include a memory on which computer-executable instructions may be maintained, where the instructions may be executable by one or more processors. Such instructions and other data may be stored using a variety of computer-readable media. A computer-readable medium (also referred to as a processor-readable medium or storage) includes any non-transitory (e.g., tangible) medium that participates in providing data (e.g., instructions) that may be read by a computer (e.g., by the processor of the vehicle component interface template server 134 or personal device 104). In general, processors receive instructions, e.g., from the memory via the computer-readable storage medium, etc., and execute these instructions, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C #, Objective C, Fortran, Pascal, Visual Basic, Java Script, Perl, Python, PL/SQL, etc.

The vehicle identifiers 156 may include various types of unique identifiers that are associated with the vehicles 102. In an example, the vehicle identifiers 156 may be vehicle identification number (VIN) serial numbers that are assigned to vehicles 102 by vehicle manufacturers in accordance with ISO 3833. As some other examples, the vehicle identifiers 156 may include identifiers of user accounts associated with the vehicles 102, such as MYFORD MOBILE user account identifiers, e-mail addresses, device identifiers of authorized personal devices 104 such as those included in the paired device data 152, or unique codes installed to the TCU 124 or the wireless transceiver 130 of the vehicle 102.

The personal device 104 may send a request to the vehicle component interface template server 134 to provide the one or more interface templates 120, 122 based on the unique identifier 148 received from the in-vehicle component 106. In an example, the vehicle component interface application 118 may send to the vehicle component interface template server 134 the unique identifier 148 for which the rich content interface template 122 is to be provided. The vehicle component interface template server 134 may query its own storage to identify the rich content interface template 122 corresponding to the unique identifier 148, and may send the identified rich content interface template 122 to the personal device 104.

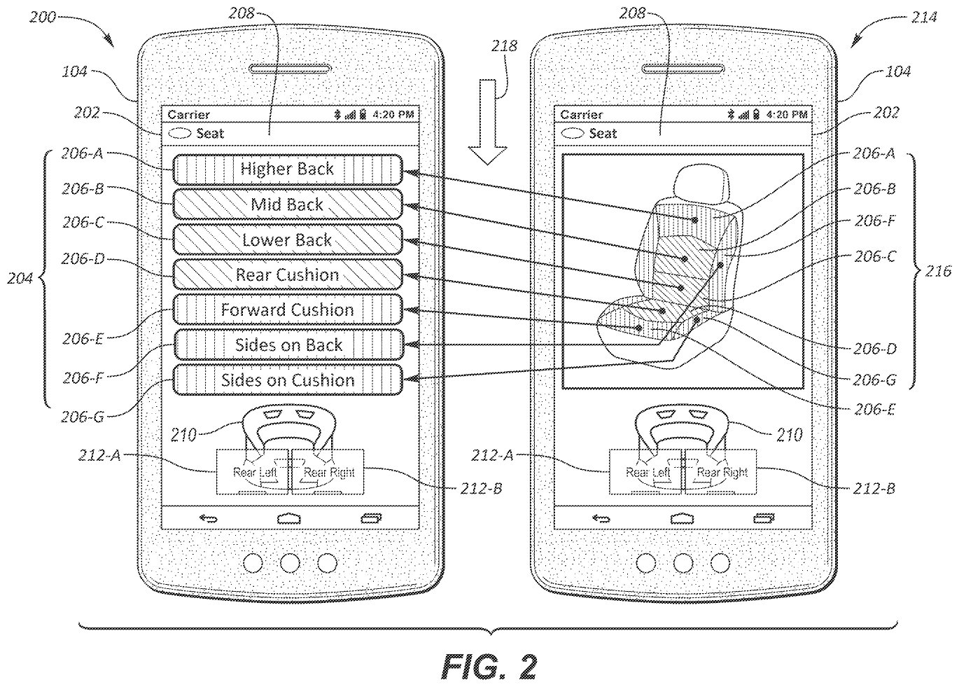

FIG. 2 illustrates an example user interface 200 derived from a low-footprint content interface template 120 and an example user interface 214 derived from a rich content interface template 122. For example, the user interface 200 includes information related to features of a seat in-vehicle component 106. The user interface 200 may be generated by the vehicle component interface application 118 based on the information collected from the characteristics of the service of the in-vehicle component 106, and may be provided to the display 202 of the personal device 104. The user interface 200 may include a presentation 204 configured to display selectable controls 206 based on the identified in-vehicle components 106 features. Each of the selectable controls 206 (e.g., 206-A through 206-G in the illustrated example) may indicate a function of the indicated in-vehicle component 106 that is available for configuration by the user. For example, each enumerated characteristic of the services of the in-vehicle component 106 may be represented in the presentation 204 as a separate selectable control 206. The user interface 200 may also include a title label 208 to indicate to the user that the user interface 200 is displaying a menu of functions of the indicated in-vehicle component 106 (e.g., a seat as shown).

As illustrated, the presentation 204 is a listing includes a control 206-A for toggling on and off a massage function of the higher back of the seat in-vehicle component 106, a control 206-B for toggling on and off a function of the middle back of the seat in-vehicle component 106, a control 206-C for toggling on and off a function of the lower back of the seat in-vehicle component 106, a control 206-D for toggling on and off a function of the rear cushion of the seat in-vehicle component 106, a control 206-E for toggling on and off a function of the forward cushion of the seat in-vehicle component 106, a control 206-F for toggling on and off a function of the back bolsters of the seat in-vehicle component 106, and a control 206-G for toggling on and off a function of the cushion bolsters of the seat in-vehicle component 106. The presentation 204 may further indicate the current statuses of the enumerated characteristics. For instance, characteristics that indicate functions that are active may be indicated in an active state (e.g., in a first color, with a selected checkbox, in highlight, etc.), while characteristics that indicate functions that are not active may be indicated in an inactive state (e.g., in a second color different from the first color, with an unselected checkbox, not in highlight, etc.).

The presentation 204 may also provide for scrolling in cases where there are more controls 206 that may be visually represented in the display 202 at one time. In some cases, the controls 206 may be displayed on a touch screen such that the user may be able to touch the controls 206 to make adjustments to the functions of the in-vehicle component 106. As another example, the user interface 200 may support voice commands. For example, to toggle the higher back function, the user may speak the voice command “HIGHER BACK.” It should be noted that the illustrated presentation 204 and controls 206 are merely examples, and more or different functions or presentations 204 of the functions of the in-vehicle component 106 may be utilized.

In some examples, the user interface 200 may further include a zone interface 210 to select additional in-vehicle components 106 that are available inside the vehicle 102 within different zones 108. As one possibility, the zone interface 210 may include a control 212-A for selection of a driver-side rear zone 108-C, and a control 212-B for selection of a passenger-side rear zone 108-D (collectively controls 212). Responsive to selection of one of the controls 212, the user interface 200 may accordingly display the controls 204 of corresponding in-vehicle component 106 for the selected zone 108. For instance, if the seat controls in the zone 108-C is currently being displayed and the user selects the control 212-B to display the corresponding seat controls for the zone 108-D, the user interface 200 may display the functions of the seat control for the zone 108-D.

The user interface 214 is derived from a rich content interface template 122 and includes information related to the same features of the seat in-vehicle component 106 included in the user interface 200. However, the rich content interface template 122 includes additional content that, as shown, may be used to generate a more engaging user interface 214. For instance, the rich content interface template 122 may be based on HTML, XHML, SVG, XAML, JSON, and/or another markup, object-oriented, or vector graphic format for describing the user interface 214, as well as, media such as graphics and sounds referenced by the rich content interface template 122. The rich content interface template 122 may further indicate locations on the screen and/or types of controls to be rendered on the screen to display the functions and statuses of the functions in-vehicle component 106. As one possibility, the rich content interface template 122 may include a web content version of the user interface 214 to be rendered by a web browser, where the web content includes links that, when, selected, indicate requests to invoke various features of the in-vehicle component 106.

For sake of explanation, as compared to the example user interface 200 which displays a listing-style presentation 204 of the controls 206, the example user interface 214 instead displays a graphical image of the seat itself in a graphical presentation 216 of the controls 206. Notably, the same set of functionality (e.g., the controls 206-A through 206-G) is available in the user interface 214. Thus, as compared to the listing in the user interface 200, the user interface 214 illustrates the functions of the in-vehicle component 106 at the locations of the in-vehicle component 106 to which they relate.

While the user interface 200 and user interface 214 may display the same features differently, the interaction between the personal device 104 and the in-vehicle component 106 to be controlled may be handled similarly. For instance, as the user manipulates a control on the example user interface 214, an identifier of the feature to be controlled from the rich content interface template 122 is matched to a control identifier of the low-footprint content interface template 120.

An example mapping 218 of the controls 206 of the graphical presentation 216 to the controls 206 of the list presentation 204. The low-footprint content interface template 120 may then be used to communicate the desired interaction to the in-vehicle component 106. Thus, regardless of which user interface 200 or 214 is used, the interaction with the in-vehicle component 106 may be performed with a relatively low footprint.

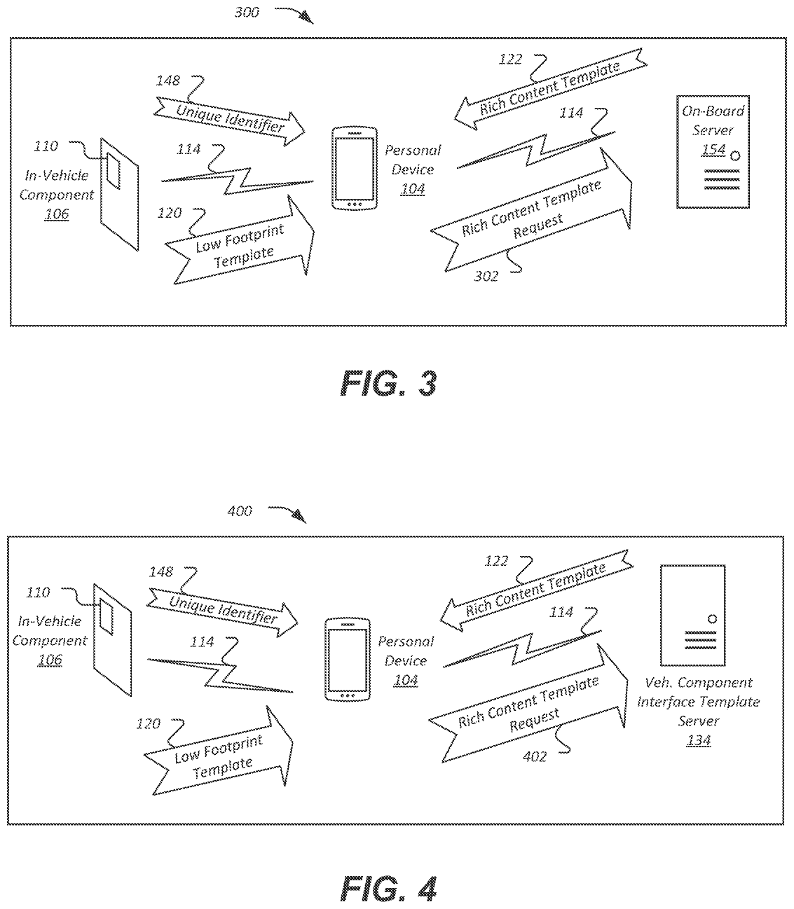

FIG. 3 illustrates an example system 300 for sending a request for the rich content user interface template 122 to the on-board server 154 of the vehicle 102. In one example, the in-vehicle component 106 may be configured to broadcast messages including the low-footprint interface template 120. The in-vehicle component 106 may also be configured to broadcast messages including the unique identifier 148 indicating the corresponding rich content interface template 122. The low-footprint interface template 120 and the unique identifier 148 broadcasted by the in-vehicle component 106 may be advertised together in a single broadcast message or in separate periodically alternating broadcast messages.

In response to receiving the unique identifier 148, the personal device 104 may be configured to send a request 302 to the on-board server 154 to provide the rich content interface template 122 corresponding to the received unique identifier 148. The on-board server 154 may query its own storage to identify the rich content interface template 122 corresponding to the unique identifier 148 received from the personal device 104. Upon identification of the rich content interface template 122, the on-board server 154 may be configured to send the template 122 to the personal device 104 for generating the rich content interface corresponding to the in-vehicle component 106.

Additionally or alternatively to the system 300 described in reference to FIG. 3, shown in FIG. 4 is an example system 400 for receiving the rich content user interface template 122 from the vehicle component interface template server 134. As with the system 300, the in-vehicle component 106 may advertise the unique identifier 148 indicating the corresponding rich content interface template 122 to the one or more personal devices 104 in the vicinity of the component 106.

In response to receiving of the unique identifier 148, the personal device 104 may, accordingly, send a request 402 to the vehicle component interface template server 134 to provide the rich content interface template 122 based on the received identifier 148. The vehicle component interface template server 134 may identify the rich content interface template 122 corresponding to the unique identifier 148 and may send the template 122 to the personal device 104, such that a rich content interface may be generated for the broadcasting in-vehicle component 106.

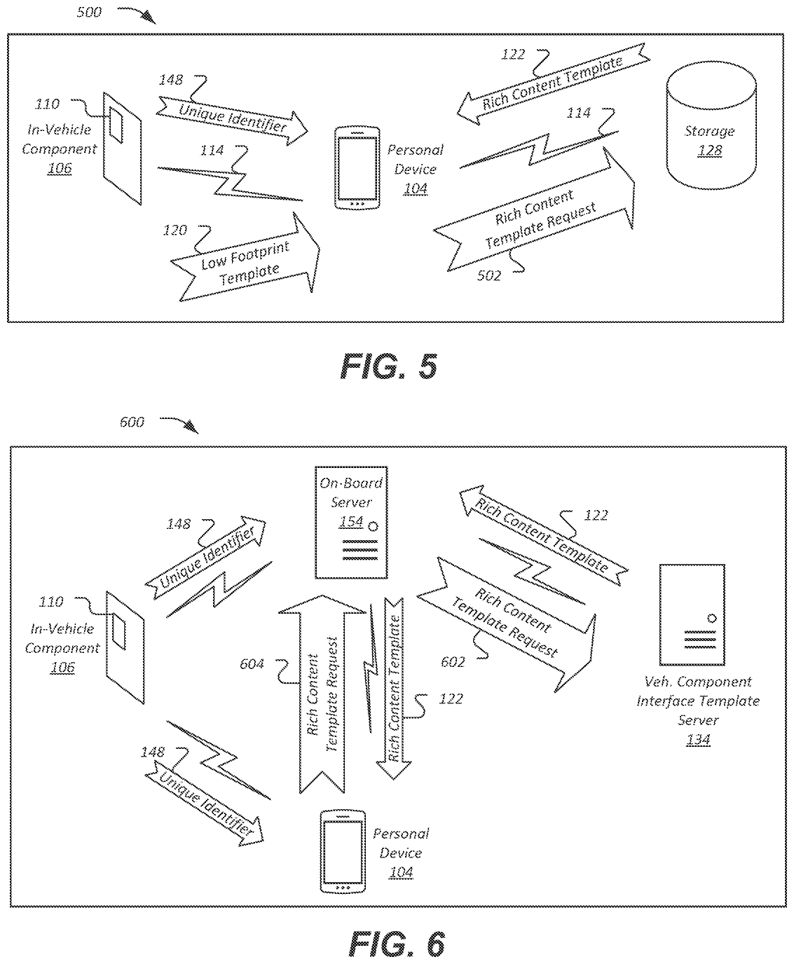

In another example, as shown in FIG. 5, the personal device 104 of an example system 500 may be configured to request the rich content interface template 122 from a local storage. Upon receipt of the unique identifier 148 from the in-vehicle component 106, the personal device 104 may, accordingly, send a request 502 to the TCU 124 to provide the rich content interface template 122. The TCU 124 may be configured to query the storage 128 to identify the template 122 that corresponds to the received unique identifier 148. Furthermore, the TCU 124 may send the identified template 122 to the personal device 104 that sent the request 502.

In still another example, as illustrated in an example system 600 of FIG. 6, the on-board server 154 may be configured to detect one or more messages broadcasted by the in-vehicle components 106. The on-board server 154 may, for instance, be configured to receive the in-vehicle component 106 broadcast including the unique identifier 148 for which the rich content interface template 122 may be requested at a later date, e.g., by the personal device 104. Based on the received identifier 148, the on-board server 154 may query the storage to identify the corresponding rich content interface template 122. If the corresponding template 122 is not available in the storage, the on-board server 154 may send a request 602 to the vehicle component interface template server 134 to provide the template 122. In response to receiving the corresponding template 122 from the vehicle component interface template server 134, the on-board server 154 may then store the received template 122 in the storage in association with the unique identifier 148.

As further illustrated in FIG. 6, the personal device 104 may be configured to, in response to receiving the unique identifier 148 from the in-vehicle component 106, send a request 604 to the on-board server 154 to provide the rich content interface template 122. Upon receiving the request 604 and the unique identifier 148, the on-board server 154 may be configured to query the storage to determine whether the rich content interface template 122 corresponding to the received identifier 148 is available. If the corresponding template 122 is not available, the on-board server 154 may be configured to send an error notification to the personal device 104 that initiated the request 604. In response to identifying the template 122 that corresponds to the received identifier 148, the on-board server 154 may send the identified template 122 to the personal device 104 that, in turn, may generate a rich content interface based thereupon.

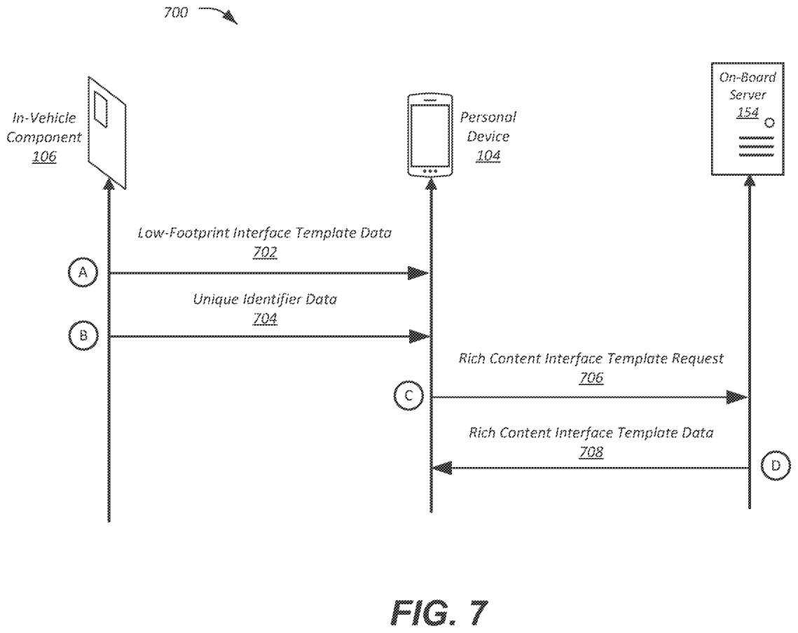

FIG. 7 illustrates an example information exchange flow 700 between the personal device 104, the in-vehicle components 106, and the on-board server 154. With reference to the examples of FIGS. 1A-1D, four passengers are shown as sharing a ride in the vehicle 102 including the on-board server 154. The passengers may have entered the vehicle 102 carrying their personal devices 104. For sake of explanation, the example information exchange flow 700 may be performed between those in-vehicle components 106, personal devices 104, and the on-board server 154.

As shown in the information exchange flow 700, at time index (A) the personal devices 104 may receive low-footprint interface template data 702, e.g., embedded in universally unique identifiers (UUIDs) of the Bluetooth protocol, from the one or more in-vehicle components 106 located in the same zones 108 as the personal device 104. The low-footprint interface template data 702 may comprise a visual representation of the functionality associated with the in-vehicle components 106 and so on.

The unique identifier data 704 indicative of the rich content interface template 122 corresponding to the broadcasting in-vehicle component 106 may be received by the personal device 104 at time index (B). In one example, the retrieval of the low-footprint interface template data 702 and/or the retrieval of the unique identifier 148 may be responsive to a request from the personal device 104 to connect to the in-vehicle component 106, a request from the user to configure the in-vehicle component 106 (e.g., via the vehicle component interface application 118, via user interaction with the controls of the in-vehicle component 106, etc.), and so on.

In an example, the low-footprint interface template data 702 may be retrieved by the personal device 104 and compiled into a low-footprint content interface template 120 for the in-vehicle component 106. The low-footprint interface template data 702 may be specified by characteristic UUIDs of the characteristics of the service UUID of the in-vehicle component 106. The minimal definition of the low-footprint content interface template 120 may include, for example, information decoded from the characteristic UUIDs, such as a listing of names and/or identifiers of the available features of the in-vehicle component 106 and/or information indicative of the current state of the in-vehicle component 106. The personal device 104 may store the low-footprint content interface template 120 to the memory 144 of the personal device 104, to allow for the low-footprint content interface template 120 to be available for later use. In an example, the low-footprint content interface template 120 may be indexed in the memory 144 according to service identifier of the in-vehicle component 106 to facilitate its identification and retrieval.

If the in-vehicle component 106 supports providing a rich content user interface, at time index (C) the personal device 104 sends a request 706 to the on-board server 154 to provide the rich content interface template 122 to the personal device 104. The rich content interface template 122 may include interface based on a markup language or an object-oriented language, such as HTML, XHTML, SVG, XAML, and JSON, as some non-limiting examples, as well as additional media content references by the programming language that may be used to generate the user interface, such as graphics, sound, and indications of haptic effects, as some non-limiting examples. Thus, the rich content interface template 122 may define a presentation of content including media content and selectable controls that, when invoked, request that various functions of the in-vehicle component 106 be performed. In some cases, personal device 104 may be further configured to delay a predetermined amount of time to allow other personal devices 104 within the vehicle 102 to complete the initial transfer of user interface information from the in-vehicle component 106 before sending the request for the rich content interface template 122.

The personal device 104 may receive, from the on-board server 154, rich content interface template data 708 indicative of the rich content interface template 122, at time index (D). The rich content interface template 122 may be saved on permanent storage of the personal device 104. In an example, the rich content interface template 122 may be indexed in the memory according to a service identifier of the in-vehicle component 106 to facilitate its identification and retrieval. Thus, if the personal device 104 later identifies an advertisement for the in-vehicle component 106 having the same service identifier in the same or a different vehicle 102, the rich content interface template 122 (and/or low-footprint content interface template 120) may be directly and quickly acquired from the storage of the personal device 104.

Notably, because of the potential large number of personal devices 104 present in the vehicle 102, it might take some time before the rich content interface template 122 is fully available for use in generation of a user interface by the personal device 104. However, as the low-footprint content interface 200 may be compiled based on an enumeration of the characteristics exposed by the in-vehicle component 106, the low-footprint content interface template 120 may quickly be retrieved. Accordingly, the low-footprint content interface template 120 may allow for presentation of a user interface in the event the passenger intends to interact with some interior feature before the rich content interface template 122 has been fully retrieved. Therefore, when a passenger, for example someone located in the rear driver-side zone 108-C as shown in FIG. 1A, reaches for an in-vehicle component 106, or otherwise initiates interaction with it, the best interface template available to the personal device 104 may be used to facilitate the user interaction with the in-vehicle component 106.

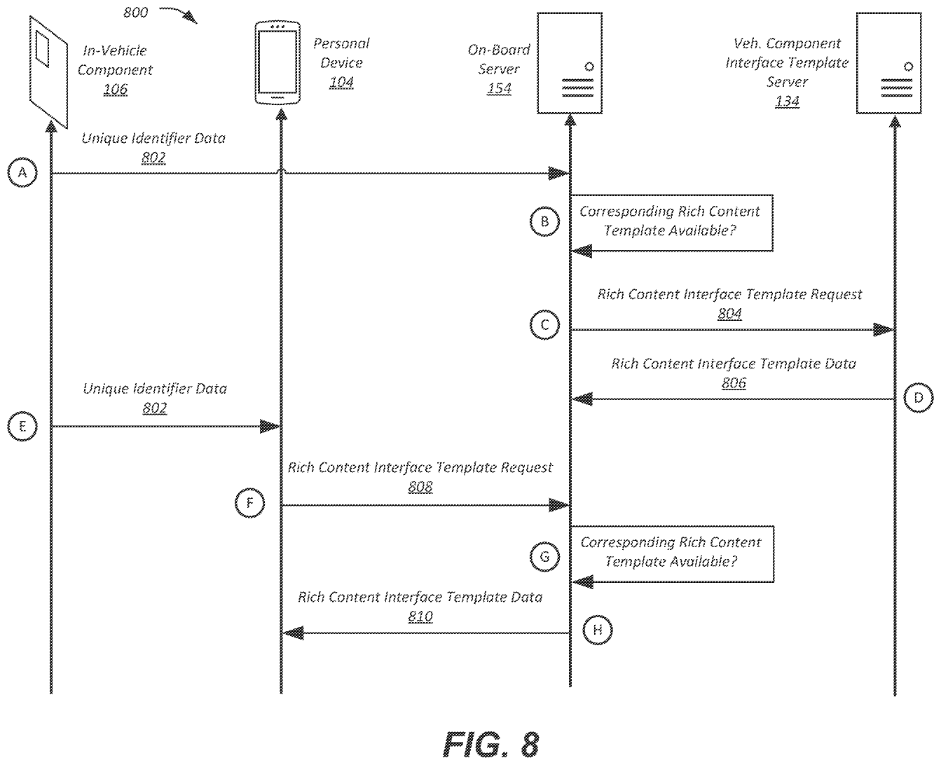

FIG. 8 illustrates an example information exchange flow 800 between the personal device 104, the in-vehicle component 106, the on-board server 154, and the vehicle component interface template server 134 as described, for example, with reference to the examples of FIGS. 1A-1D. As shown in the information exchange flow 800, at time index (A) the on-board server 154 may receive the unique identifier 148 broadcasted by the in-vehicle component 106 and indicative of the corresponding rich content interface template 122.

The on-bard server 154 may query its own storage to identify the corresponding rich content interface template 122 based on the received unique identifier 148, at time index (B). If the rich content interface template 122 is not available, the on-board server 154 may send a request 804 to the vehicle component interface template server 134, at time index (C), to provide the rich content interface template 122 corresponding to the unique identifier 148.

The on-board server 154 may receive rich content interface template data 806 from the vehicle component interface template server 134, at time index (D). The on-board server 154 may store the rich template 122 in storage for later use, such as, for example, in response to a request from the personal device 104 to provide the template 122.

At time index (E), the personal device 104 may receive the unique identifier data 802, e.g., embedded in the Bluetooth protocol UUIDs, from the one or more in-vehicle components 106 located in the same zones 108 as the personal device 104. The unique identifier data 802 may comprise a reference to the rich content interface template 122 corresponding to the in-vehicle components 106 and so on.

The personal device 104, at time index (F) sends a request 808 to the on-board server 154 to provide the rich content interface template 122 to the personal device 104, wherein the template 122 may be based on one or more interface markup languages, such as HTML, XHTML, SVG, XAML, JSON, as some non-limiting examples, as well as additional media content references by the markup language that may be used to generate the user interface, such as graphics, sound, and indications of haptic effects, as some non-limiting examples.

At time index (G), the on-board server 154 may query its own storage to identify the corresponding rich content interface template 122 based on the received unique identifier 148. In response to determining that the interface template 122 is available, the on-board server 154 may send the rich content interface template data 810 to the personal device 104, at time index (H). The personal device 104 may save the received rich content interface template 122 on permanent storage of the personal device 104, such as by indexing the template 122 in the memory according to a service identifier of the in-vehicle component 106 to facilitate its identification and retrieval.

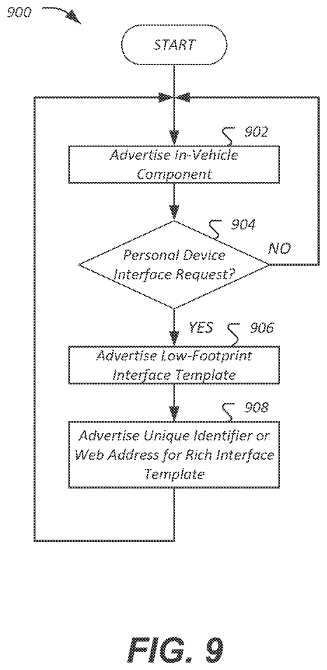

FIG. 9 illustrates an example process 900 for advertising, by the in-vehicle component 106, of the low-footprint interface template 120 and the unique identifier 148 indicative of the corresponding rich content interface template 122. The process 900 may begin at operation 902, in which the in-vehicle component 106 advertises its own presence, e.g., by broadcasting periodic BLE advertisements for receipt by the personal devices 104 in the vicinity of the in-vehicle component 106.

The in-vehicle component 106 determines, at operation 904, whether a connection request has been received from the personal device 104. If a connection request has not been received, the in-vehicle component 106 may return to operation 902 where it advertises its own presence by making period broadcasts.

Upon receiving a connection request from the personal device 104, the in-vehicle component 106, at operation 906, begins to advertise the low-footprint interface template 120. At operation 908, the in-vehicle component 106 begins to advertise the unique identifier 148 indicative of the rich content interface template 122 of the in-vehicle component 106. The in-vehicle component 106 may continue advertising one or more of the low-footprint interface template 120 and the unique identifier 148 for a predefined period of time prior to returning to the operation 902 where it broadcasts its own presence.

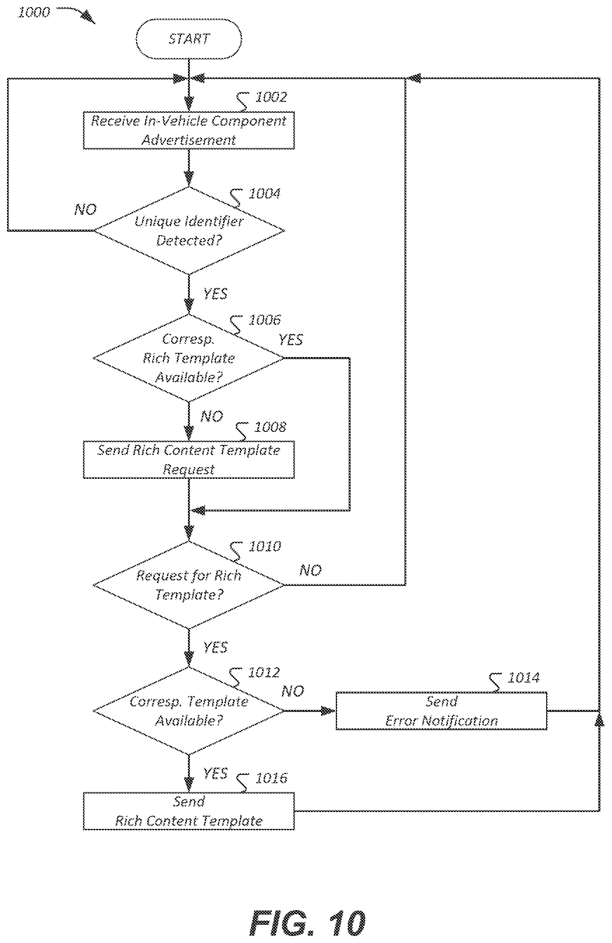

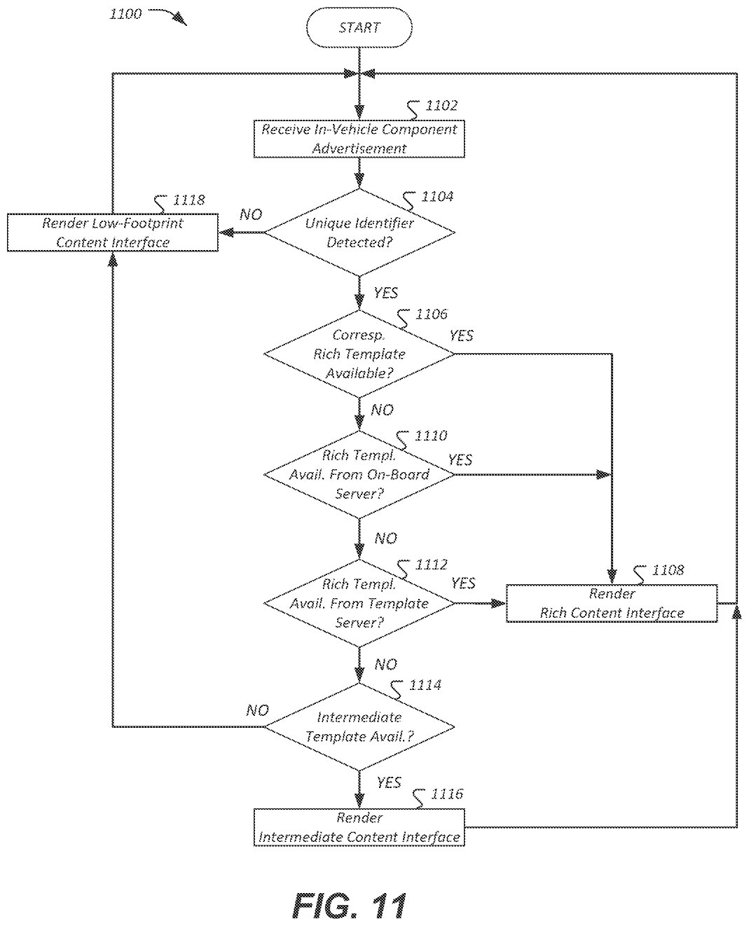

FIG. 10 illustrates an example process 1000 for providing, to the personal device 104, the rich content interface template 122 that was previously received by the on-board server 154 of the vehicle 102. The process 1000 may begin at operation 1002, in which the on-board server 154 may receive an advertisement data from the in-vehicle components 106. In one example, the on-board server 154 may detect the advertisement in response to scanning for in-vehicle components, e.g., using a scanning service and so on.

At operation 1004, the on-board server 154 may determine whether the unique identifier 148 indicative of the corresponding rich content interface template 122 is included with the received advertisement. If the unique identifier 148 is included, the on-bard server 154 may query its own storage to identify the corresponding rich content interface template 122 based on the received unique identifier 148, at operation 1006.

In response to determining the rich content interface template 122 is not available, the on-board server 154 may send a request to the vehicle component interface template server 134, at operation 1008, to provide the rich content interface template 122 corresponding to the unique identifier 148. The on-board server 154 may store the rich content interface template 122 received from the vehicle component interface template server 134 in storage for later use, such as, for example, in response to a request from the personal device 104 to provide the template 122.

At operation 1010, the on-board server 154 determines whether a request from the personal device 104 to provide the rich content interface template 122 has been received. In one example, the personal device 104 may send a template 122 request to the on-board server 154 in response to receiving the unique identifier 148 from the in-vehicle component 106, along with or separately from the low-footprint interface template 120.

In response to the request, the on-bard server 154, at operation 1012, may query its own storage to determine whether the corresponding rich content interface template 122 based on the received unique identifier 148 is available. If the corresponding template 122 is not available, the on-board server 154 may send, at operation 1014, an error notification to the personal device 104 indicating that the requested template 122 could not be located. Upon locating the rich content interface template 122 that corresponds to the unique identifier 148 received from the personal device 104, the on-board server 154 may send the identified template 122 to the personal device 104, at operation 1016.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A system comprising:
a personal device, in communication with a vehicle component and an on-board server, including a processor programmed to:
receive, from the component, an advertisement defining a low-footprint interface template and a unique identifier of a corresponding rich content interface template,
send, to the server, a request including the identifier to provide the corresponding template, and
render a rich content user interface according to the corresponding template.

2. The system of claim 1, wherein the user interface derived from the low-footprint interface template defines a plurality of selectable controls and the user interface derived from the rich content interface template defines a graphic generated using a markup format.

3. A vehicle system comprising:
an on-board server including a data store and a wireless transceiver configured to establish communication with a personal device, the server being configured to, in response to a request from the personal device, query the data store to identify a rich content interface template corresponding to a unique identifier received with the request and, upon identification, send the corresponding template to the personal device.

4. The system of claim 3, wherein the wireless transceiver is further configured to establish communication with an in-vehicle component and an interface template server and wherein the on-board server is further configured to, in response to detecting an advertisement, from the vehicle component, including the unique identifier and a query of the data store to identify the corresponding template returning zero results, send, to the interface template server, a request including the identifier to provide the corresponding template and store the corresponding template in the data store upon receipt.
